(19) United States
(12) Patent Application Publication
(10) Pub. No.: US 2002/0147725 A1
(43) Pub. Date: Oct. 10, 2002

(54) Method and apparatus for database table definition

(75) Inventors: Ocke Janssen, Hamburg (DE); Frank Schoenheit, Hamburg (DE)

Correspondence Address: Forrest Gunnison, Gunnison, McKay & Hodgson, L.L.P., Suite 220, 1900 Garden Road, Monterey, CA, 93940, US

(73) Assignee: Sun Microsystems, Inc.

(21) Appl. No.: 10/118,201

(22) Filed: Apr. 5, 2002

(30) Foreign Application Priority Data
Apr. 5, 2001 (EP) 01 108 609.7

(51) Int. Cl. G06F 7/00

(52) U.S. Cl. 707/100

(57) ABSTRACT

A computer-based method for defining properties of columns of database tables includes receiving a user input selecting at least one source column of a first database table as a source from which metadata defining the properties of said at least one source column is to be copied, receiving a user input selecting a location of a definition table as a target into which said metadata is to be copied wherein said definition table defines column properties of a second database table, and copying said metadata from said source to said target to define the properties of at least one column of said second database table such that said at least one column of said second database table corresponds to the definition of the properties of said at least one source column of said first database table selected as said source.

### BACKGROUND OF THE INVENTION

1. Field of the Invention

The present invention relates generally to database tables, and more particularly to the definition of database tables.

2. Description of Related Art

Databases are widely distributed for organizing, managing and querying data in an ordered form. So-called relational databases are based on table structures in which the data is organized in columns and rows. One row typically is called a data set or a data record, and the columns typically contain different attributes for the individual data sets.

To explain some basic principles of databases reference is made to FIG. 1A, which illustrates a database table 100 for a film or movie database. Database table 100 includes a plurality of rows 101_1 to 101_j. Each row in table 100 corresponds to an individual movie. Each of columns 102_1 to 102_5 corresponds to a different attribute for the individual movie.

Each field in a second column 102_2, with column header FNAME, contains a film name. Each field in a third column 102_3, with column header FLENGTH, contains a film length. Each field in a fourth column 102_4, with column header FTEXT, contains a descriptive text for the film.

Each field in first column 102_1, with column header FID, contains a so-called primary key. The primary key in column FID is a unique identifier for each dataset in the plurality of datasets 101_1 to 101_j in table 100. In general, a primary key is a unique identification that is used for identifying the individual data sets (the rows) of each table.

Another basic concept, the so-called “relations” is explained in connection with a fifth column 102_5, with a column header GID, which contains a so-called genre identification number. Relational databases typically are organized into a plurality of database tables, and one field of a first database table may refer to a database record of another database table. This is the case for values in genre ID column GID as explained below.

FIG. 2 shows another table 200, a so-called genre table, in which the genre information is stored. Each field of a first column 202_1, with a column header GID, contains a genre ID. The values in genre ID column GID are the primary keys of table 200. Each field of a second column 202_2, with a column header GNAME, contains the genre name, such as action, drama, comedy, etc., and each field of a third column 202_3, with a column header GTEXT, contains some explanatory text.

Each of tables 100 and 200 has a so-called primary key in its first column 102_1 and 202_1, respectively. Last column 102_5 of table 100, which contains genre ID, has the same type of data as first column 202_5 of table 200 that also contains genre ID. With this configuration, a value in last column 102_5 of a dataset in movie table 100 references a corresponding dataset in genre table 200, i.e., the dataset having the same value in first column 202_1 of table 200.

With this kind of reference, relations between different tables can be generated. It is possible, for example, to insert genre information in a dataset contained in table 200 only once. Any other tables via values in genre ID column GID can then refer to this genre information without the need for further inputting of the actual genre information in any of these other tables.

FIG. 3 illustrates a graphical user interface 300 for defining relations between different tables, e.g., tables 100 AND 200. In this interface, the columns of a table are identified by the column header names contained in the columns of that table. In a right-hand window 320, column header names of genre table 200 are listed. Thus, window 320 is referred to as a genre table window 320. In a left-hand window 310, column header names of movie table 100 are listed.

A connecting line 330 between genre ID column GID of genre table window 320 and genre ID column GID of movie table window 310 illustrates a relation between these two columns. The numbers respectively given at the two ends of line 330 illustrate that this is a 1 to n relation, which means that many fields in column GID of movie table 100 may refer to the same genre field of genre table 200. For example, many films can have the genre name comedy, action, or the like.

The definition and the actual implementation of such relations are well known in the art, they are implemented, for example, in STARBASE database software, which is included in STAROFFICE software produced by Sun Microsystems (STARBASE and STAROFFICE are trademarks of Sun Microsystems of Palo Alto, Calif.). As is well known in the art, much more complex relations can be generated between individual database tables.

When creating a new database, it is very important to plan the structure of the database. This means one has to think about the structure of the individual database tables. For each database table, the attribute values stored in each individual column have to be defined with respect to their format, their content, etc.

Typically, a graphical user interface, called a table design view, is used for defining the columns of a database table. Interface 150 (FIG. 1B) is an example of a table design view that includes a definition table. Each row of the definition table corresponds to a column in the database table defined by the definition table.

In a first column 152_1, a user can input the name of a column. In a second column 152_2, the user selects a type for the data in the column, and in a third column 152_3, the user gives a description of the attribute stored in the column. From a comparison of FIGS. 1A and 1B, one can see that the definition (or design) in interface 150 (FIG. 1B) corresponds to database table 100 (FIG. 1A).

Table design view 150 gives a simplified illustration of the input options for defining column properties. Many other properties and definitions also can be required or can be possible, depending on the actual database implementation.

For example, for each database table column which is defined in one row of the definition table of FIG. 1B, one could also define the length of the data which is to be contained in the database table column, one could define whether an input is required or whether the fields in the database table column may remain empty, etc. Depending on the database software actually used, such additional information can be inputted either directly into the definition table shown in FIG. 1B (then the definition table would contain more columns for the additional information), or this additional information assumes predefined values which can be altered by a user.

Another possibility would be to provide further input windows or input forms for enabling the user to input the further column definition information required. How this possibility to input the actual column definition data, which also are called metadata, is implemented depends on the actual database software used. It is, however, well known to the skilled person to implement a user interface for defining the column properties of a table (the metadata).

What becomes apparent from the description so far is the fact that for each table of a database the columns and their properties have to be defined by inputting some information as shown exemplarily in FIG. 1B. Because for each database table such definition data has to be inputted, the definition needs considerable user effort.

### SUMMARY OF THE INVENTION

According to an embodiment of the present invention, a method for generating the definition of the properties of database columns uses already existing column definitions of a first database table for defining the properties of one or more columns of a second database table. This becomes possible by selecting one or more source columns of the first database table from which metadata is to be copied as a source, further by selecting a target in a definition table, and finally copying the metadata from the source into the target thereby defining the properties of at least one column of the second database table.

This embodiment defines the column properties of database tables in a much easier way without manually inputting the metadata for each individual column of each database table. A user may select as a source for copying any column of any already existing database table and copy the corresponding metadata into a target definition table for defining the table properties of a column of another table. According to an embodiment of the invention, more than one source columns can be selected, and the metadata of the so selected source columns are simultaneously copied into the definition table of a second database table.

In another embodiment, a computer-based method for defining properties of columns of database tables receives a user input selecting at least one source column of a first database table as a source from which metadata defining the properties of the at least one source column is to be copied. Also received is a user input selecting a location of a definition table as a target into which the metadata is to be copied. The definition table defines column properties of a second database table. The metadata is copied from the source to the target to define the properties of at least one column of the second database table such that the at least one column of the second database table corresponds to the definition of the properties of the at least one source column of the first database table selected as the source.

In yet another embodiment, a computer-based method comprising:

receiving cursor information to determine one or more source columns of a first database table as a source location;

receiving a copy request for copying metadata information for the one or more source columns;

reading the metadata information for said one or more source columns;

receiving cursor information to determine a target location;

copying the metadata information from the source location and the target location.

In still yet a further embodiment, computer-based method includes:

defining a database table by a collection of sets of variables, each of said sets corresponding to one column of said database table;

defining properties of at least one column of said database table by a corresponding set of variables in said collection of sets of variables;

selecting a target location in said database table for a new column;

creating a new variable set at an intermediate location between already existing sets of variables to define the properties of said new column, if a set of variables already exists for said target location;

creating, alternatively, a new variable set at said target location, if a set of variables does not already exist for said target location; and

copying metadata variable values into said new variable set.

An apparatus for defining the properties of columns of database tables includes means for receiving a user input selecting at least one source column of a first database table as a source from which metadata defining the properties of the at least one source column is to be copied; means for receiving a user input selecting a location of a definition table as a target into which the metadata is to be copied wherein the definition table defines column properties of a second database table; and means for copying the metadata from the source to the target to define the properties of at least one column of the second database table such that the at least one column of the second database table corresponds to the definition of the properties of the at least one source column of the first database table selected as the source.

Yet another apparatus for defining the properties of columns of database tables includes: means for receiving cursor information to determine one or more source columns; means for receiving a copy request for copying metadata information for the one or more source columns; means for reading the metadata information for said one or more source columns; means for receiving cursor information to determine a target location; and means for writing the metadata information to the target location.

In one embodiment, a computer program product has stored thereon computer readable instructions wherein execution of the computer readable instructions generates a method for defining the properties of columns of database tables, the method comprising:

receiving a user input selecting at least one source column of a first database table as a source from which metadata defining the properties of the at least one source column is to be copied;

receiving a user input selecting a location of a definition table as a target into which said metadata is to be copied wherein said definition table defines column properties of a second database table;

copying the metadata from the source to the target to define the properties of at least one column of the second database table such that the at least one column of the second database table corresponds to the definition of the properties of the at least one source column of the first database table selected as the source.

### BRIEF DESCRIPTION OF THE DRAWINGS

FIG. 1A is an illustration of a prior art database table.

FIG. 1B is an illustration of an interface that includes a definition table for the prior art database table of FIG. 1A.

FIG. 2 is an illustration of another prior art database table.

FIG. 3 is an illustration of an interface demonstrating an n to one relation between a column in the prior art database table of FIG. 1A and the prior art database table of FIG. 2.

FIG. 4A illustrates a system that include one embodiment of the present invention.

FIG. 4B illustrates a selection of a source column and a primary key target in a definition table according to one embodiment of the invention.

FIG. 4C illustrates the definition table after the metadata information for the source column of FIG. 4B is copied, as appropriate, to the primary key target according to one embodiment of the invention.

FIG. 4D illustrates a selection of a source column and a target in a definition table according to one embodiment of the invention.

FIG. 4E illustrates the definition table after the metadata information for the source column of FIG. 4D is copied to the target according to one embodiment of the invention.

FIG. 4F illustrates a selection of a plurality of source columns as a source and a target in a definition table according to one embodiment of the invention.

FIG. 4G illustrates the definition table after the metadata information for the plurality of source column of FIG. 4F is copied simultaneously to the target according to one embodiment of the invention.

FIG. 4H illustrates a selection of a primary key source column and a target in a definition table according to one embodiment of the invention.

FIG. 4I illustrates the definition table after the metadata information for primary key source column of FIG. 4H is copied, as appropriate, to the target according to one embodiment of the invention.

FIG. 5 is a process flow diagram for one embodiment of the method of the present invention.

FIG. 6 is an illustration of table column description object that includes a plurality of metadata objects where each metadata object defines one column of a database table according to one embodiment of the present invention.

FIG. 7 is a more detailed process flow diagram according to one embodiment of the method of the present invention.

FIG. 8 is a more detailed process flow diagram for one embodiment of the metadata copy operation in one embodiment of the method of the present invention

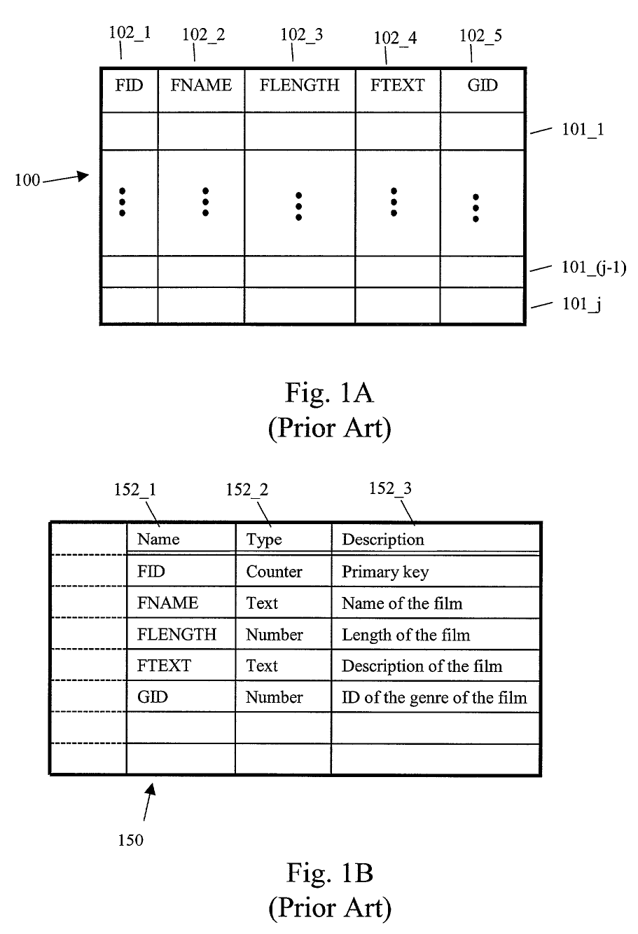

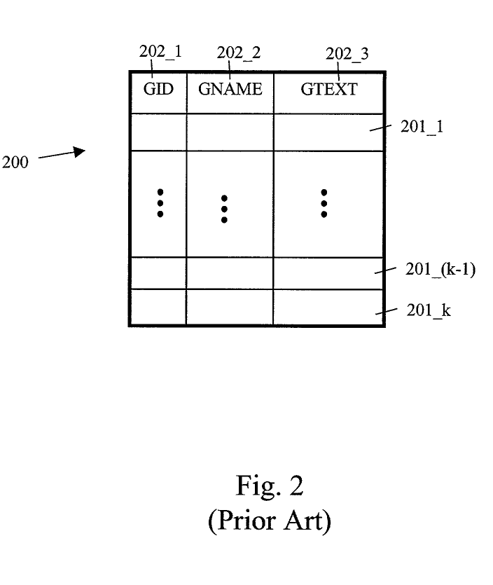

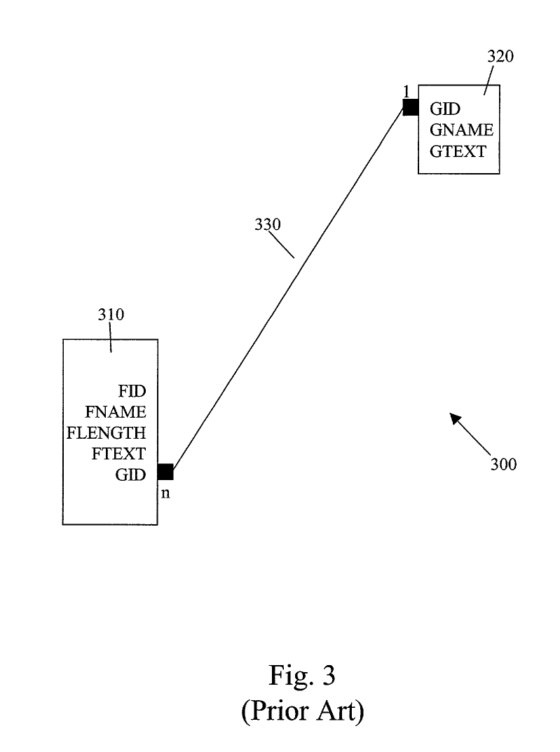

In the Figures and the following Detailed Description, elements with the same reference numeral are the same element or at least equivalent elements. Also, the first digit of a reference numeral is the figure number in which the corresponding element first appears.

### DETAILED DESCRIPTION

According to one embodiment of the present invention, a database application 440 and a method 445 executing on a computer system 430 permit a user to complete column definitions for a new database table or modify a column definition or definitions for an existing database table using a definition table 450 and at least one of a plurality of database tables 401. As explained more completely below, for each new column in the database table, the user selects a source column in the at least one database table and a row in definition table 450 that represents a target column. The metadata values for the selected column are copied into a column definition set for the target column in definition table 450. Each row of definition table 450 defines a column in the database table.

Hence, with this embodiment of the invention, any user can create a new database table or modify an existing database table using column definitions from existing database tables. The user can do this without knowing the specific column definitions. In addition, the user does not have to re-input data concerning the column to create the new column. Consequently, creating new columns in database tables and new database tables is easier and requires less work than the prior art techniques that required manual entry of the column definition for each column in a database table.

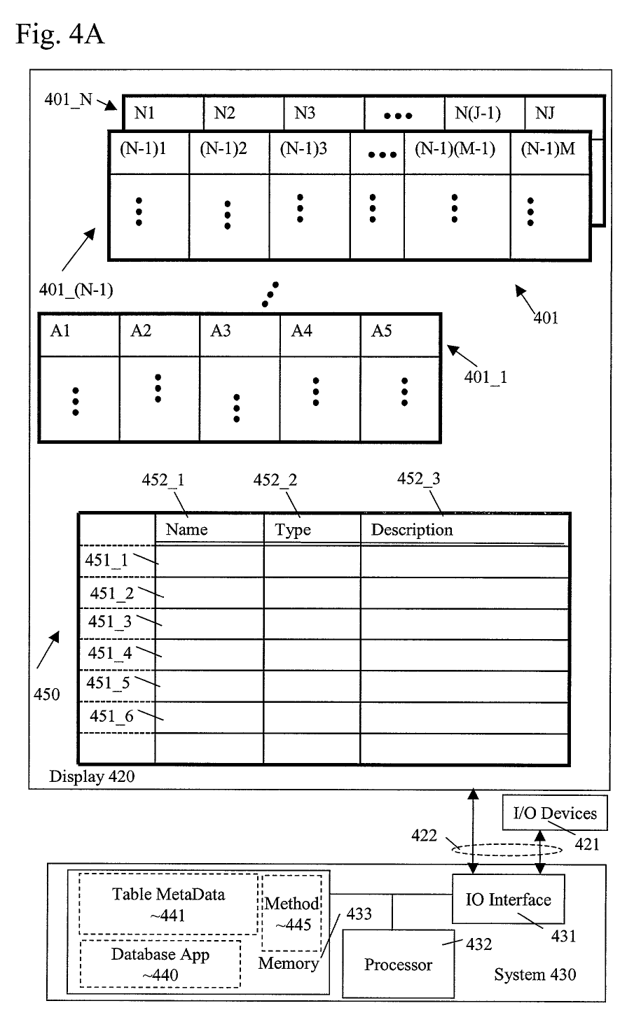

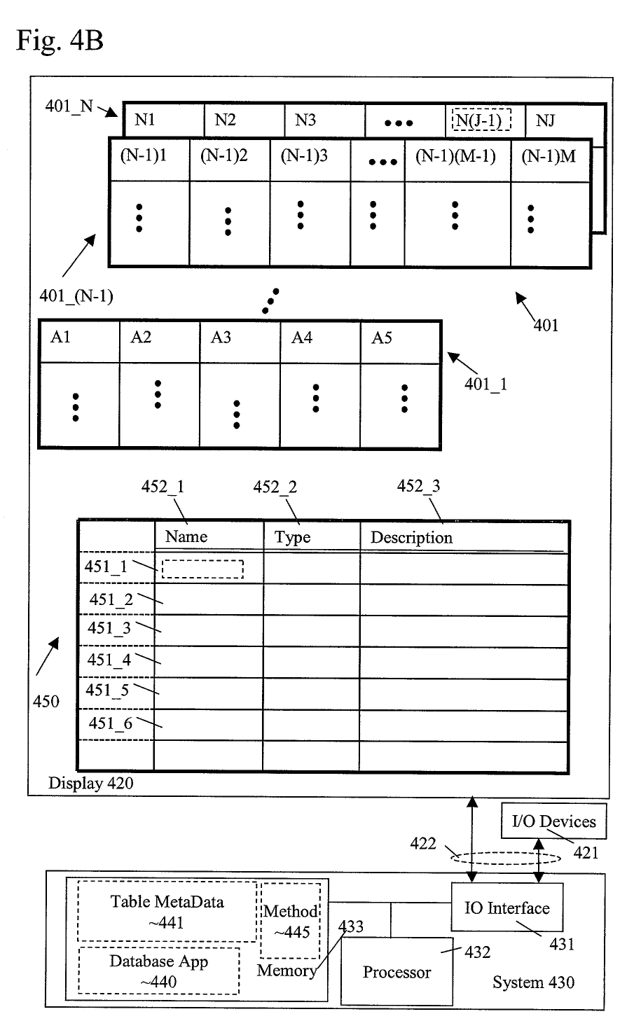

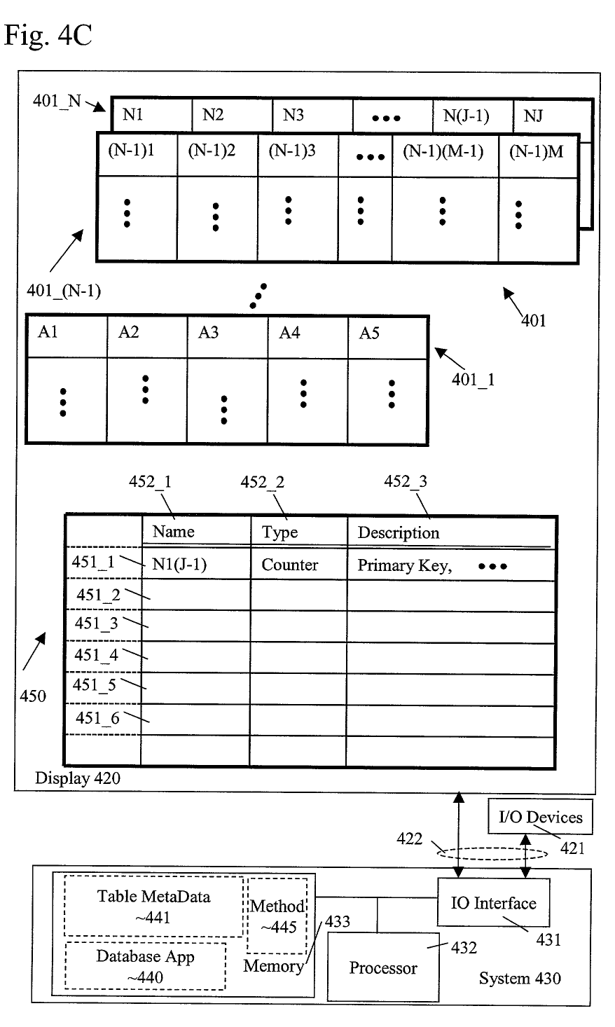

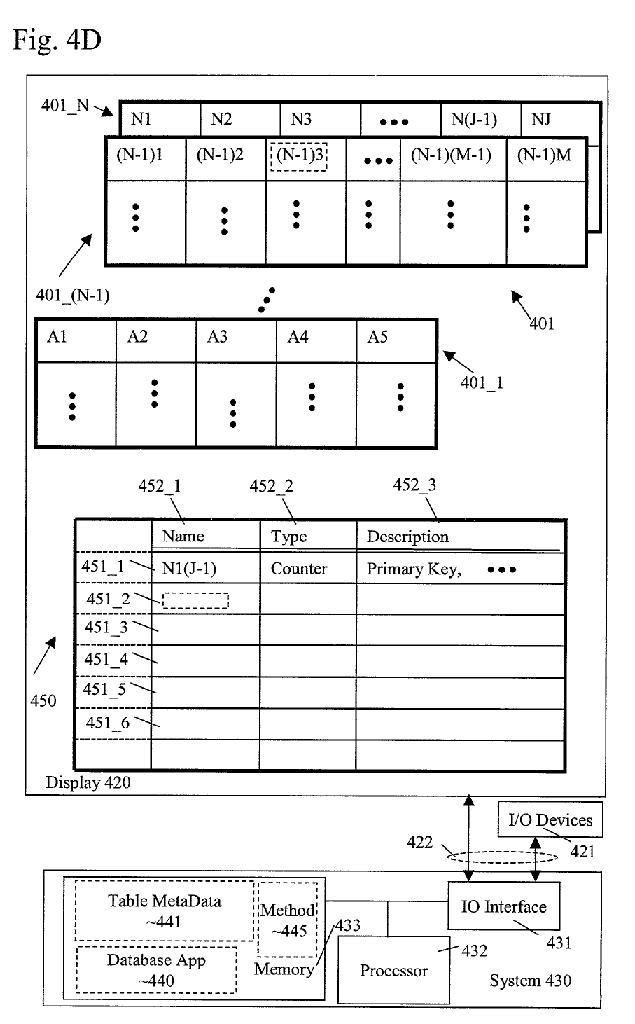

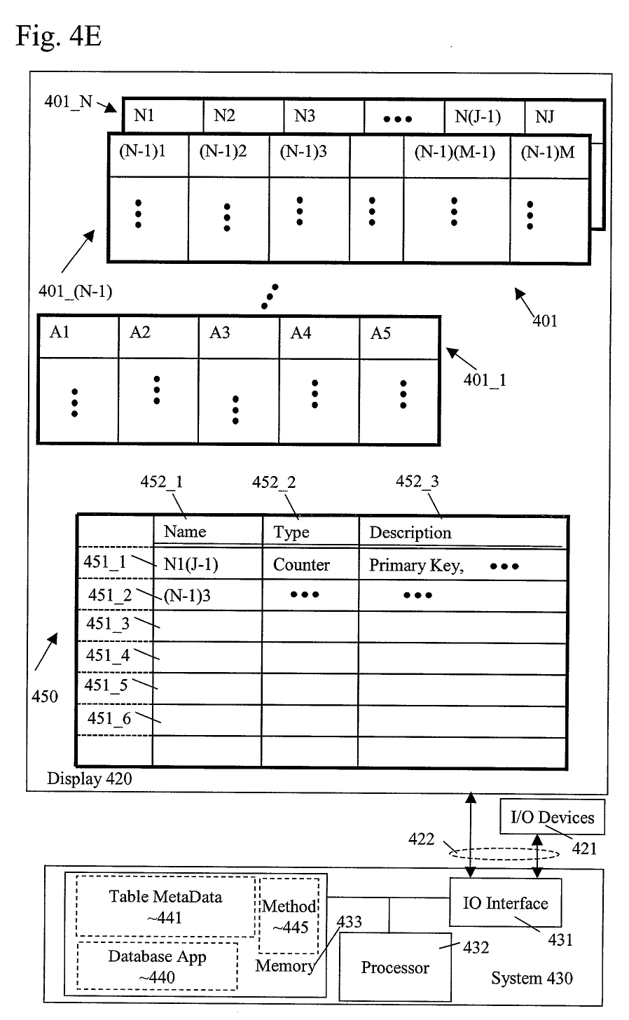

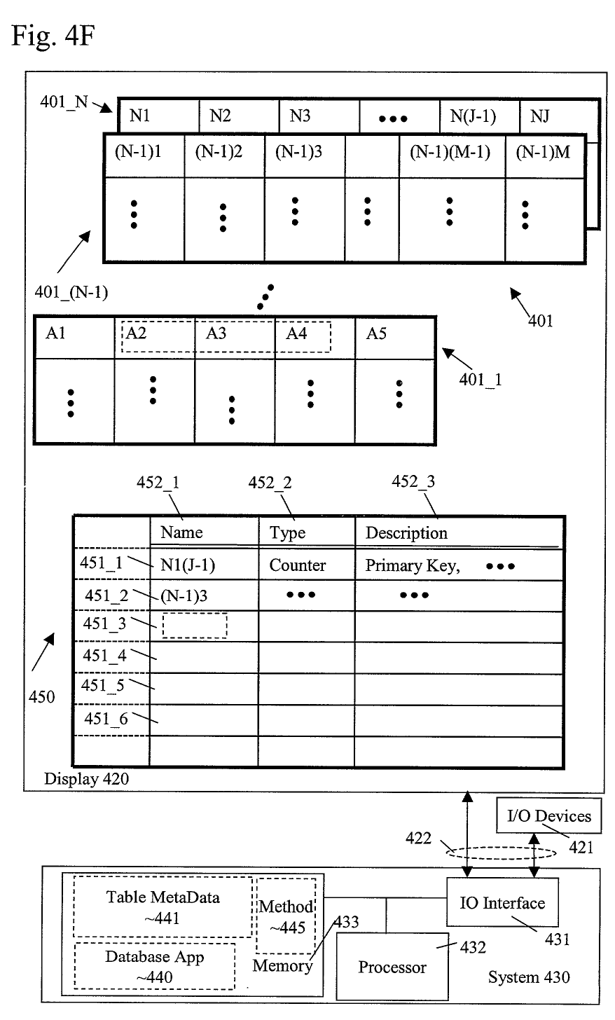

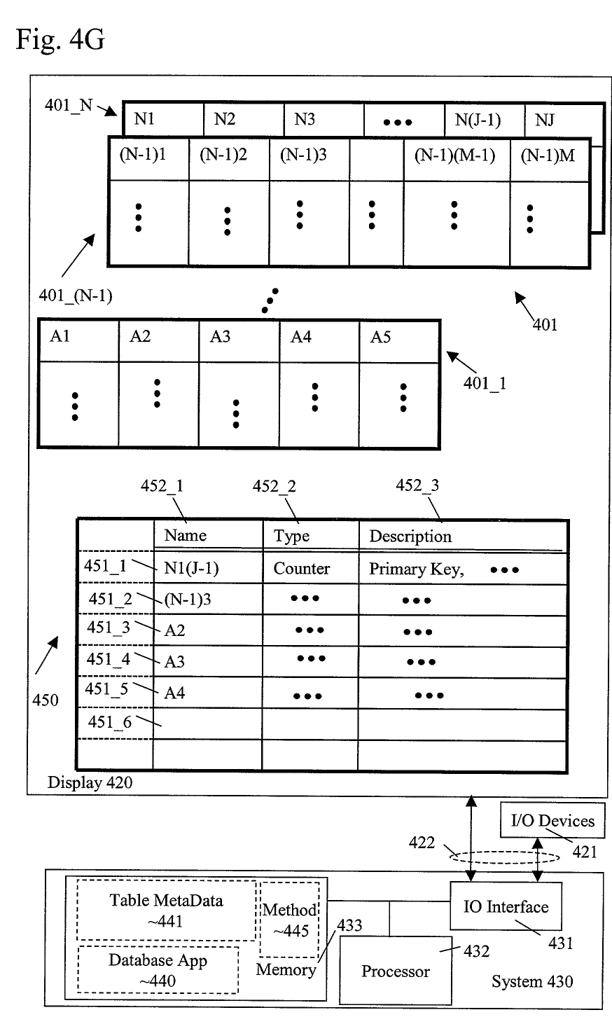

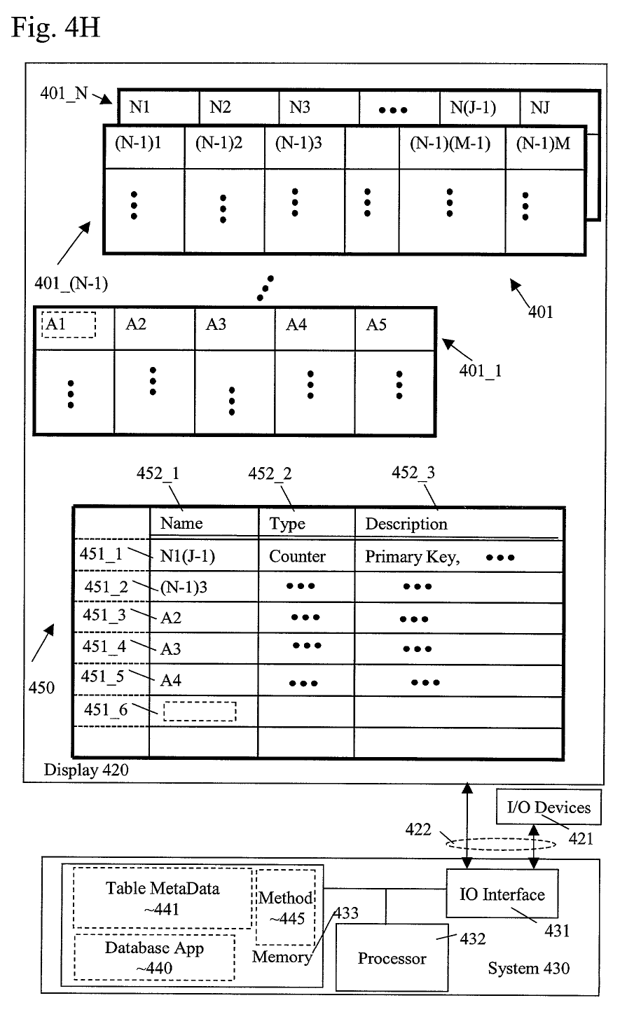

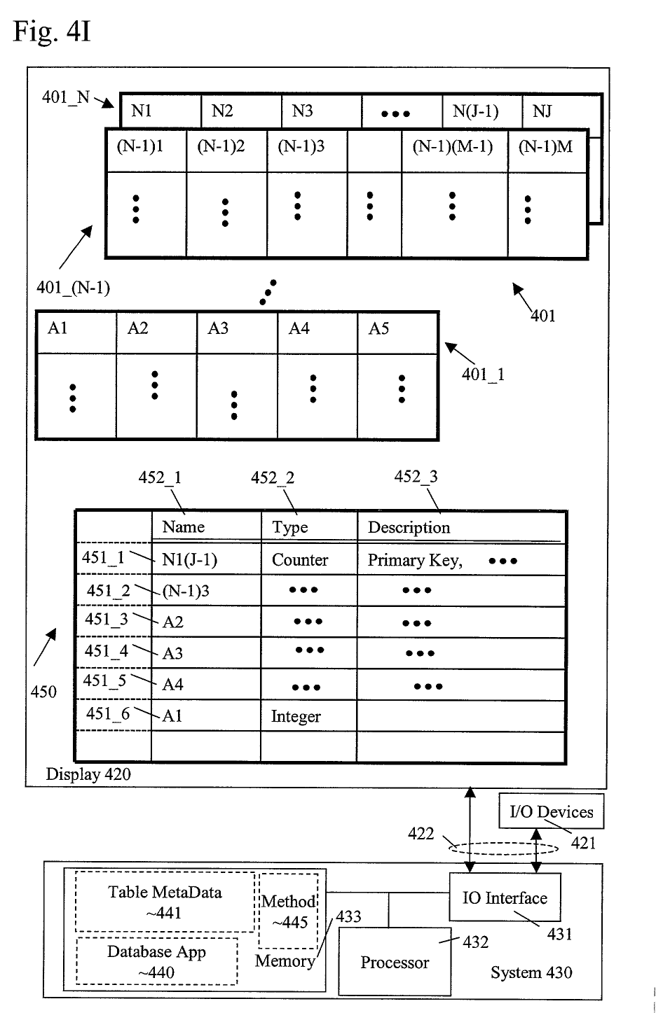

In the embodiment of FIG. 4A, a plurality of database tables 401 that includes tables 401_1 to 401_N, where N is an integer, and a definition table 450 are presented on display 420. The simultaneous display of plurality of database tables 401 and definition table 450 is only for ease of discussion and is not intended to limit the invention to this particular user interface.

In this example, definition table 450 includes three characteristics, name 452_1, type 452_2, and description 452_3, for each column that is contained in a database table. Sometimes the column characteristics are referred to as variables.

The use of three characteristics is illustrative only and is not intended to limit the invention to any particular number of characteristics. In view of this disclosure, definition table 450 is modified to include column characteristics compatible with database application 440, for example. Also, while definition table 450 may appear similar to definition table 150, definition table 450 is coupled with method 445 that provides a new level of ease in completing definition table 450 compared with definition table 150.

In a select source column operation 501, a user uses an I/O device in I/O devices 421, e.g., a computer mouse, a computer keyboard, or perhaps a speech recognition system to select a column in an existing database table. For example, in FIG. 4B, the user has selected column N(J-1) of table 401_N using a cursor. Herein, the column header designations are used as the column names.

Next in a select target operation 502, the user selects a target location in definition table 450 using a cursor, for example. In the example of FIG. 4B, the user selects row 451_1 of definition table 450, which represent the first column in the new database table.

Upon selection of row 451_1, copy metadata operation 503 copies, as appropriate, metadata for source column N(J-1) of table 401_N from table metadata 441 into the appropriate column variable set for the database table corresponding to table 450 and displays the metadata in the appropriate fields in row 451_1.

However, column N(J-1) is not a primary key for table 401_N, but row 451_1, in this embodiment, defines the primary key column for the new database table. This means that the values in the column of the new table defined by row 451_1 have to uniquely identify each dataset in the new table. This is achieved, in this embodiment, by assigning type Counter, which means that value in this column for each row of the new database table is automatically incremented. Hence, type 452_2 is set to Counter if the type for source column N(J-1) was not Counter.

In one embodiment, if the type for source column N(J-1) is not suitable for use as a primary key, the user is warned that the type for source column N(J-1) is not suitable for a primary key, and the user is asked whether the user would like to define a different target column in the database table corresponding to source column N(J-1). In this embodiment, the user can abort the copy operation, continue with the copy operation for row 451_1, or continue the copy operation for another row in definition table 450.

Assuming that the metadata for column N(J-1) is copied to row 451_1, the description in the metadata for the target column is replaced with primary key. Optionally, the description in the metadata for the target column can be appended to the primary key description. For example, if column N(J-1) is an invoice number, the description would be “Primary Key, Invoice Number,” in the metadata for the target column.

Method 445 can be repeated until the user has defined all the desired new columns in the database table corresponding to definition table 450. For example, as illustrated in FIG. 4D, the user selects column (N-1)3 of table 401_(N-1) as the source column and row 451_2 of definition table 450 as the target column. In FIG. 4E, the metadata for source column (N-1)3 of table 401_(N-1) has been copied, stored in a new column variable set, and displayed in row 451_2 of definition table 450.

In FIG. 4F, the user has selected source columns A2 to A4 of table 401_1 as the source, and row 451_3 of definition table 450 as the target. As illustrated in FIG. 4G, metadata for column A2 is copied, stored in a new column variable set, and displayed in row 451_3; metadata for column A3 is copied, stored, and displayed in row 451_4; and metadata for column A4 is copied, stored and displayed in row 451_5.

Hence, in this embodiment, the user is able define multiple columns in the database table at one time by using multiple columns from an existing database table. While in this example, the columns selected in the existing database table were adjacent to each other, this is illustrative only. In another embodiment, the user can select multiple columns from any locations in the existing database table.

Finally, in FIG. 4H, the user selects column A1 in table 401_1 and row 451_6 of definition table 450. The metadata for column A1 is copied, stored in a new variable set, and displayed, as appropriate, in the fields of row 451_6. However, column A1 is the primary key for table 401-1, but the column of the new table defined by row 451_6 is not the primary key for the new table. Consequently, the type in row 451_6 is changed, in this embodiment, from counter to number.

The user can select a column in the database table and a row in the definition table in many different ways, depending on the actual implementation. One possibility would be to use a copy and paste functionality of the task bar, which usually is provided by the operating system.

Another possibility is to use a context menu when clicking on the column header. In the context menu, a window pops up which provides the user with an option “copy metadata for this column” which when selected copies the column metadata into the clipboard. A user then moves the cursor to a row in the definition table, which could be displayed in the same or in another window on the screen, and uses a “paste” function of the taskbar or a “paste” function provided by the context menu.

Another possibility is to use the “drag and drop” functionality. A user would move the cursor onto the column header of the database table and then the user would drag and drop the metadata information into a row in the definition table.

The “copy and paste” function as well as the “drag and drop” function are functionalities well known in the art. Typically, these functionalities are provided by the operating system of a computer, and can be easily used by a programmer skilled in the art for transferring data from some a source location indicated by the cursor to some target location, which also is indicated by the cursor, for example.

In one embodiment, when the metadata for the selected source column of the database table is not compatible with the definition of the target column, the metadata is amended such that the metadata copied into the target location is not exactly identical to the metadata from the source location. The copied data is compatible with the target location. This means that all metadata for which it makes sense are copied in an identical manner, but for those metadata where an amendment is deemed necessary, such an amendment is carried out. Typically, this is the metadata, which define the source metadata as a primary key. The corresponding metadata is converted such that the metadata copied into the target location defines the corresponding table column as being of type “number” or “integer” without any auto incrementing functionality, so that the column defined by the metadata at the target location may contain the same data value several times.

It should, however, be understood that it may depend on the actual implementation which metadata are copied in an identical manner and which are amended or converted when being copied. If no amendment or adaptation is made automatically (or according to predefined or user selectable settings), in one embodiment, the copied metadata is corrected manually after copying.

In the present example, when copying metadata from a primary key column to another column, which should be able to reference the primary key as a so-called foreign key, the implementation is such that an automatic conversion is made such that the type “counter” is changed into the type “number” when copying the metadata. This is particularly useful for those cases where the source column contains a primary key and the target column should be able to refer to the source column in a n to 1 relation as described before. Depending on the type of the source and the target, however, different options also can be useful, such as copying without any conversion.

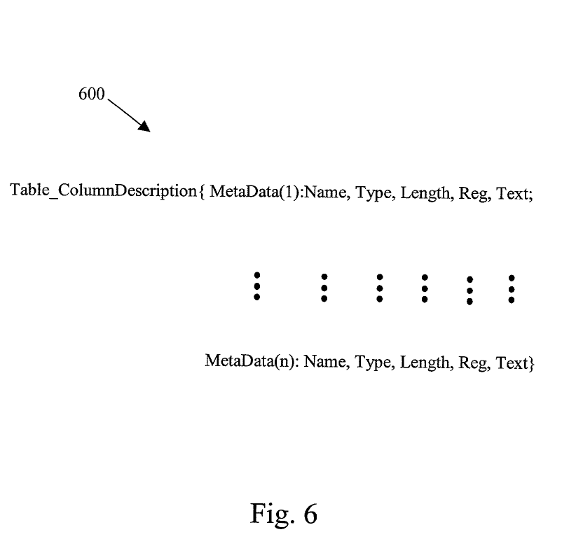

FIG. 6 illustrates one definition of metadata for database tables. Data structure 600 is used for representing the definition of columns represented by column data of one database table having n columns. An object Table_ColumnDescription contains a list of n metadata description objects for n columns. Each metadata description object contains a set of variables, which is this embodiment are Name, Type, Length, Reg, and Text. Each of objects metadata (1) to metadata (n) corresponds to a single column and defines the properties of that single column in a corresponding database table.

Variable Name defines the name of the column (the column header). Variable Type describes the type of data, such as integer, boolean, text, characters, counter, or the like. Variable Length defines the length of the data, which can be inputted into the corresponding column. Variable Length is typically of type integer and corresponds to the number of characters, which can be inputted into the corresponding column. Variable Req is typically of the type boolean and defines whether the corresponding column of the database table requires data to be inputted. If variable Req is set to false, the corresponding fields of the column may remain empty, while these fields require data to be inputted if variable Req is set to true. Variable text is typically of type string and contains some descriptive text to explain the content of the corresponding column.

It will be readily understood by the skilled reader that a column description may as well be implemented by other sets of variables. For example, instead of providing a type Counter representing the property of a column value to be incremented for each succeeding entry, the type could be set to integer and there could be a further variable autoincrement of type boolean in the set of variables. If variable autoincrement is set to true, the column values are automatically incremented for each succeeding value.

Moreover, additional variables could be provided to define further column properties. Examples could be a variable defining a currency. This variable could e.g. assume values like US$, EUR, etceteras. Also, a default value could be provided which defines which value a column field should assume before any other value has been inputted. Default values could be zero, an empty character string, or the like.

Each of objects metadata (1) to metadata (n), in one embodiment, is addressed by a corresponding pointer, and the pointer is used when the data are copied from a source definition table to a target definition table. Of course, as will be readily apparent by the skilled person, instead of addressing the variables by means of a pointer the variables may also be addressed directly.

When a new column is to be defined for a certain database table, such as the example of FIGS. 4A to 4I, a new object metadata (n+1) with a corresponding set of variables is appended to list metadata (1) to metadata (n), and the variable values of the source metadata are copied into the newly created metadata object metadata (n+1). Alternatively, and depending on the selected target location in the target table, the new metadata object could be generated at an intermediate location in list metadata (1) to metadata (n), and the subsequent metadata objects would then be renumerated accordingly, as will be readily understood by the skilled person.

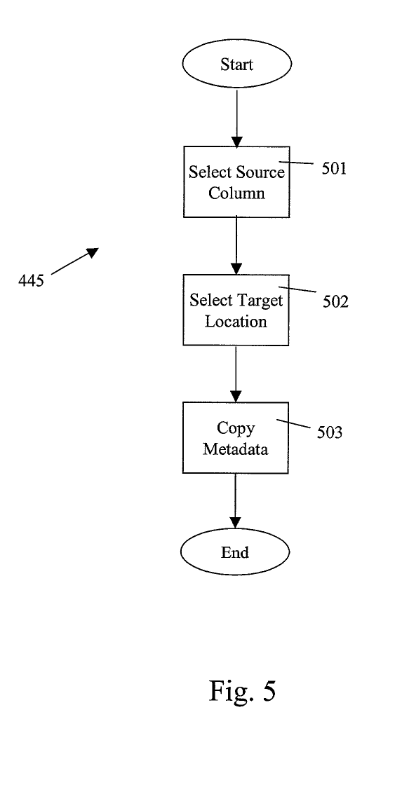

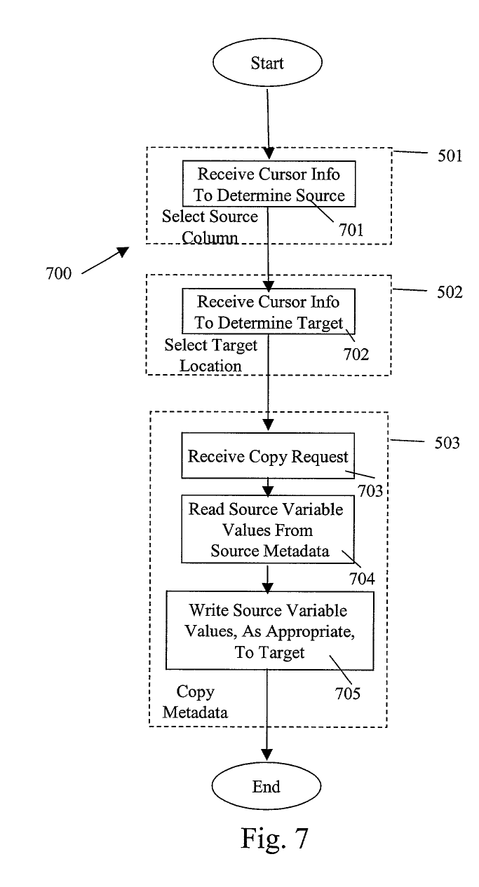

In FIG. 7, a more detailed process 700 is one embodiment of method 445. The sequence of operations in FIG. 7 is illustrative only, and is presented in the particular sequence to obtain correspondence with FIG. 5. However, in one embodiment, operations 703 and 704 that are described below are performed between operations 701 and 702. The particular sequence of operations is unimportant so long as the copy of the column metadata from a source location to a target location is accomplished.

In operation 701, cursor information is received from a user input to determine the source location of the column definition metadata variables to be copied. The cursor information, for example, can correspond to the marking of a column with the cursor, or the cursor information can correspond to moving the cursor onto a column header and holding the left mouse button to initiate a drag and drop operation.

In operation 702, cursor information is received from a user input to determine the target location into which the values of the source column definition metadata variables are to be copied. As explained before, this can be done, for example, by moving the cursor into the location of the definition table where the metadata is to be copied.

In operation 703, a copy request is received or inputted by the user for the metadata associated with the source location identified in operation 701. This, for example, can correspond to the copy function of the clipboard, or can correspond to the start of a movement of the mouse from the source column while holding the left mouse button pressed to carry out a drag and drop operation.

In one embodiment, both operations 701 and 703 are implemented by using functions provided by known operating systems, such as the Windows operating system, the Unix operating system, or the like. The practical implementation of such functions is well known to the persons skilled in the art, and these functions can be used to copy a certain piece of information from one location to another location (from the source location to a target location).

In operation 704, the values of the source column definition metadata variables corresponding to the selected source column are read out. This is done by storing the variable values at some intermediate storage location, or is carried out by generating a pointer, which points to the storage location corresponding to the variable values. Operation 704 enables the writing of the variable values into some other storage location into which they are to be copied.

Finally, in operation 705, the values of the source column definition metadata variables, e.g., the metadata information, are copied, i.e., written, into the selected target location, which corresponds to a selected row of the target definition table. As explained in above, not all the metadata information may be copied verbatim. In some situations, a value of a metadata variable is modified to be consistent for use in the target definition table.

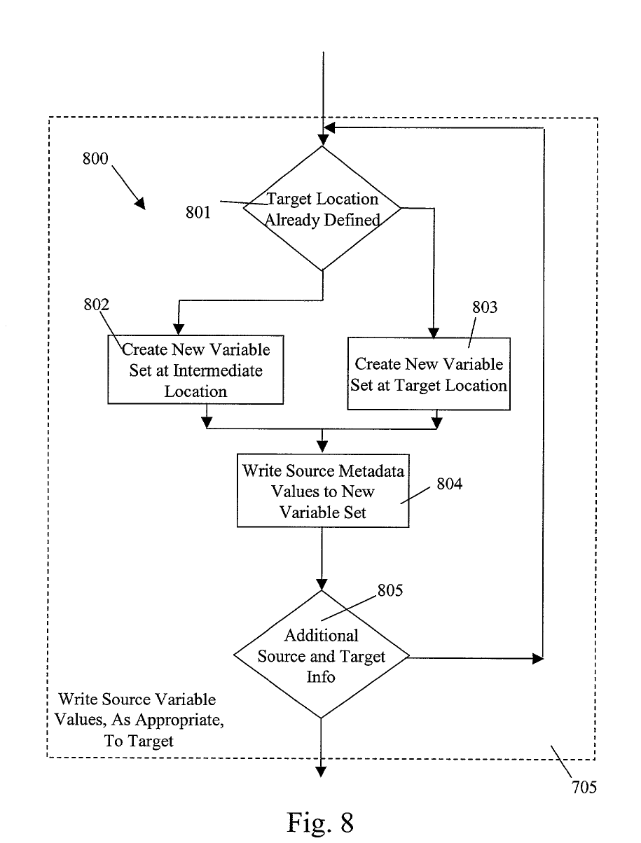

FIG. 8 is a more detailed process flow diagram 800, which explains in somewhat more detail the copying procedure according to an embodiment of the present invention. It should be noted, that the row of the definition table, which has been selected as a target, either may already contain some metadata information, or, may be empty. Depending on whether the target row is empty, the copying procedure is carried out somewhat differently, as explained more completely below.

In operation 801, the target information (the target location which corresponds to certain row of the definition table selected as a target) is checked to determine whether the target location already contains metadata, which means it is checked whether the selected row already defines the properties of a column of a database table. If this is the case, operation 801 transfers to operation 802.

In operation 802, a new variable set (metadata object) is created at a corresponding intermediate location within the list of already existing metadata objects. Operation 802 transfers to operation 804.

If in operation 801 it is determined that the target information does not correspond to an already defined column, which means that the metadata for a column to be newly defined has been selected as the target, operation 801 transfers to operation 803. In operation 803, a new variable set for column metadata is appended to any already existing sets (the already existing metadata objects). Referring to FIG. 6, this can be done by generating a new metadata object, which is appended to the list of metadata objects already contained in object Table_ColumnDescription. In other words, if n metadata objects already exist, an n+1th metadata object is additionally generated. Operation 803 also transfers to operation 804.

In operation 804, the read source variable values are written into the newly created metadata object. Operation 804 transfers to operation 805.

Operation 805 checks whether additional source and target information has been selected. This means, that it is checked whether the user by using the cursor has selected another source containing column definitions and another target into which the source metadata is to be copied. If yes, then the procedure returns to operation 801 and if no, then the copy procedure ends. If more than one column were marked as a source, operations 801, 802, 803 and 804 are accordingly carried out, as appropriate, for a plurality of metadata sets (metadata objects) as will be readily apparent to the skilled person.

The embodiments of the present invention are applicable to a hardware configuration like a personal computer or a workstation, so that system 430 is a personal computer or a workstation. However, the embodiments may also be applied to a client-server configuration. In this case, display 420 and I/O devices 421 are associated with a client device, and memory 433 and processor 432 are typically associated with a server device. For the client-server configuration, the source and the target for copying may be displayed on a display screen 420 of a client device while some or all operations of the method as illustrated before are carried out on one or more server computer accessible by a client device over a data network such as the Internet using a browser application or the like.

Method 445 executing on either a stand alone computer system or a client-server computer system provides means for receiving a user input selecting at least one source column of a first database table as a source from which metadata defining the properties of the at least one source column is to be copied; means for receiving a user input selecting a location of a definition table as a target into which the metadata is to be copied wherein the definition table defines column properties of a second database table; and means for copying the metadata from the source to the target to define the properties of at least one column of the second database table such that the at least one column of the second database table corresponds to the definition of the properties of the at least one source column of the first database table selected as the source.

Embodiments of the invention as a whole or in part may be implemented by a computer program or a computer program product. A computer program product may take the form of any data carrier such as floppy disks, CD-ROMs, DVDs, PROMs, EPROMs, EEPROMs, or the like, having recorded thereon computer executable instructions which when carried out by a computer cause said computer to perform a method according to an embodiment of the invention.

A computer program product could also take any other form suitable for embodying computer executable instructions, such as a signal transmitted through a communications link, a network connection, or within a computer itself and representing computer executable instructions.

While the invention has been particularly shown with the reference to embodiments thereof, it will be understood by those skilled in the art that various other changes in the form and details may be made therein without departing from the spirit and scope of the invention. The source for copying may for example also consist of database tables, which are the result of a query of a database. A user may query a database and may receive, depending on the actual query, a result output in form of a table, and a column of such an output table may also be selected as a source for metadata copying. Depending on the actual query, a user may thereby very quickly be provided with a table columns for which the metadata have already been generated, and from such a table he may then just copy the metadata avoiding the need for manually typing it in.

We claim:

1. A computer-based method for defining properties of columns of database tables, said method comprising:
receiving a user input selecting at least one source column of a first database table as a source from which metadata defining the properties of said at least one source column is to be copied;
receiving a user input selecting a location of a definition table as a target into which said metadata is to be copied wherein said definition table defines column properties of a second database table; and
copying said metadata from said source to said target to define the properties of at least one column of said second database table such that said at least one column of said second database table corresponds to the definition of the properties of said at least one source column of said first database table selected as said source.

2. The method of claim 1, wherein
said selecting at least one source column is performed using a cursor and said copying is performed by using the copy and paste function of a clipboard.

3. The method of claim 1, wherein
said selecting and copying are performed by using a drag and drop function.

4. The method of claim 1, wherein said receiving a user input selecting at least one source column of a first database table as a source further comprises:
selecting a plurality of source columns of said first database table wherein said plurality of source columns includes said at least one source column.

5. The method of claim 1 wherein said metadata comprises:
a column name;
a column type; and
a description of the column data.

6. The method of claim 5 wherein said metadata further comprises:
a column length; and
a variable indicating whether data is required.

7. A computer-based method comprising:
receiving cursor information to determine one or more source columns of a first database table as a source location;
receiving a copy request for copying metadata information for said one or more source columns;
reading the metadata information for said one or more source columns;
receiving cursor information to determine a target location; and
copying the metadata information from said source location to said target location.

8. A computer-based method comprising:
defining a database table by a collection of sets of variables, each of said sets corresponding to one column of said database table;
defining properties of at least one column of said database table by a corresponding set of variables in said collection of sets of variables;
selecting a target location in said database table for a new column;
creating a new variable set at an intermediate location between already existing sets of variables to define the properties of said new column, if a set of variables already exists for said target location;
creating, alternatively, a new variable set at said target location, if a set of variables does not already exist for said target location; and
copying metadata variable values into said new variable set.

9. An apparatus for defining the properties of columns of database tables, said apparatus comprising:
means for receiving a user input selecting at least one source column of a first database table as a source from which metadata defining the properties of said at least one source column is to be copied;
means for receiving a user input selecting a location of a definition table as a target into which said metadata is to be copied wherein said definition table defines column properties of a second database table; and
means for copying said metadata from said source to said target to define the properties of at least one column of said second database table such that said at least one column of said second database table corresponds to the definition of the properties of said at least one source column of said first database table selected as said source.

10. The apparatus of claim 9, wherein
said selecting at least one source column is performed using a cursor and said copying is performed by using the copy and paste function of a clipboard.

11. The apparatus of claim 9, wherein
said selecting and copying are performed by using a drag and drop function.

12. The apparatus of claim 9, wherein said receiving a user input selecting at least one source column of a first database table as a source further comprises:
selecting a plurality of source columns of said first database table wherein said plurality of source columns includes said at least one source column.

13. The apparatus of claim 9, wherein said metadata comprises:
a column name;
a column type; and
a description of the column data.

14. The apparatus of claim 13, wherein said metadata further comprises:
a column length; and
a variable indicating whether data is required.

15. An apparatus for defining the properties of columns of database tables, said apparatus comprising:
means for receiving cursor information to determine one or more source columns;
means for receiving a copy request for copying metadata information for said one or more source columns;
means for reading said metadata information for said one or more source columns;
means for receiving cursor information to determine a target location; and
means for writing the metadata information to said target location.

16. A computer program product having stored thereon computer readable instructions wherein execution of the computer readable instructions generates a method for defining the properties of columns of database tables, said method comprising:
receiving a user input selecting at least one source column of a first database table as a source from which metadata defining the properties of said at least one source column is to be copied;
receiving a user input selecting a location of a definition table as a target into which said metadata is to be copied wherein said definition table defines column properties of a second database table; and
copying said metadata from said source to said target to define the properties of at least one column of said second database table such that said at least one column of said second database table corresponds to the definition of the properties of said at least one source column of said first database table selected as said source.

17. The computer program product of claim 16, wherein
said selecting at least one source column is performed using a cursor and said copying is performed by using the copy and paste function of a clipboard.

18. The computer program product of claim 16, wherein
said selecting and copying are performed by using a drag and drop function.

19. The computer program product of claim 16, wherein said receiving a user input selecting at least one source column of a first database table as a source further comprises:
selecting a plurality of source columns of said first database table wherein said plurality of source columns includes said at least one source column.

20. The computer program product of claim 16, wherein said metadata comprises:
a column name;
a column type; and
a description of the column data.

21. The computer program product of claim 20, wherein said metadata further comprises:
a column length; and
a variable indicating whether data is required.
